(19) United States
(12) Patent Application Publication
(10) Pub. No.: US 2026/0063230 A1
(43) Pub. Date: Mar. 5, 2026

(54) FLUID CONNECTOR

(71) Applicants: Foxconn (Kunshan) Computer Connector Co., Ltd., Kunshan (CN); Foxconn Interconnect Technology Limited, Grand Cayman (KY)

(72) Inventors: HSIU-YUAN HSU, New Taipei (TW); Yao-Chi Huang, New Taipei (TW); Wen He, Kunshan (CN); Ling Tao, Shenzhen (CN); Ling-Xiong Li, Shenzhen (CN)

(21) Appl. No.: 19/317,565

(22) Filed: Sep. 3, 2025

(30) Foreign Application Priority Data
Sep. 5, 2024 (CN) 202411244595.5

(51) Int. Cl. F16L 37/38

(52) U.S. Cl. CPC F16L 37/38

(57) ABSTRACT

A fluid connector includes a shell having a fluid channel, a valve member rotatably accommodated in the fluid channel and having a through hole, a control element connected to the valve member for controlling the valve member to rotate between a closed position and an open position, and an interlock system. The shell has an interface to abut a mating connector and an accommodating hole concavely formed from the interface. The interlock system includes two pins coaxially accommodated in the accommodating hole and a resilient system. The control element is operatively connected to the interlock system via a restricting member and an operating member.

### BACKGROUND OF THE INVENTION

### Field of the Invention

The present invention relates to a fluid connector, particularly to a fluid connector preventing leakage, which has a simple structure and is easy to manufacture.

### Description of Related Arts

U.S. Pat. No. 4,438,779 discloses a fluid connector including a shell defining a fluid channel, a ball valve rotatably accommodated in the shell, and a handle connected to the ball valve for controlling the ball valve to rotate between a closed position and an open position. The shell is concavely formed with a through hole for accommodating a lock pin. When the fluid connector abuts a mating connector, the handle drives the ball valve to rotate to an open position and drives the lock pin to extend into the mating connector so that the lock pin can prevent rotation between the fluid connector and the mating connector. However, when the fluid connector does not abut the mating connector, the handle also permits the valve to rotate to the open position, producing the risk of leakage.

### SUMMARY OF THE INVENTION

A fluid connector comprises a shell having a fluid channel; a valve member rotatably accommodated in the fluid channel and having a through hole; a control element connected to the valve member for controlling the valve member to rotate between a closed position in which the valve member obstructs the fluid channel and an open position in which the valve member does not obstruct the fluid channel; and an interlock system; wherein the shell having an interface is used to abut a mating connector and an accommodating hole concavely formed from the interface to accommodate the interlock system; wherein the interlock system includes a first pin selectively movable within the accommodating hole between a first position in which the first pin protrudes outwardly from the interface and a second position in which the first pin retracts inwardly compared to the first position, a second pin movable within the accommodating hole, and a resilient system arranged with respect to the first pin and the second pin; when the fluid connector does not abut the mating connector, the resilient system maintains the first pin in the first position, and the interlock system further includes a restricting member preventing the control element from rotating the valve member; and when the fluid connector abuts the mating connector, the first pin is biased from the first position to the second position, and the control element is free of restriction by the restricting member so that the control element can operate the valve member to rotate between the closed position and the open position; and wherein the fluid connector further includes an operating member operatively connected to the control element and the interlock system; when the control element opens the valve member, the second pin can be pushed to an extending position by the operating member; and when the control element closes the valve member, the second pin can move to a retracting position accommodated in the accommodating hole.

### BRIEF DESCRIPTION OF DRAWINGS

FIG. 1 shows a perspective view of a fluid connector and a mating connector before abutting along an axis according to the invention;

FIG. 2 shows a perspective view of the fluid connector and the mating connector after abutting along an axis according to the invention;

FIG. 3 shows a cross-sectional view of FIG. 2;

FIG. 4 shows a perspective view of the fluid connector according to the invention before abutting;

FIG. 5 shows a cross-sectional view along cut line A-A of FIG. 4;

FIG. 6 shows an exploded view of the fluid connector according to the invention;

FIG. 7 shows an exploded view of FIG. 6 from another perspective;

FIG. 8 shows a perspective view of a control element connected to a restricting member, an operating member, and an interlock system;

FIG. 9 shows a view of FIG. 8 from another perspective;

FIG. 10 shows a cross-sectional view along cut line B-B of FIG. 4;

FIG. 11 shows a perspective view of the fluid connector according to the invention after abutting, with the control element operating a valve member rotated to a closed position;

FIG. 12 shows a perspective view of the fluid connector according to the invention after abutting, with the control element operating a valve member rotated to an open position;

FIG. 13 shows a cross-sectional view along cut line C-C of FIG. 4;

FIG. 14 shows a cross-sectional view along cut line D-D of FIG. 11; and

FIG. 15 shows a cross-sectional view along cut line E-E of FIG. 12.

### DETAILED DESCRIPTION OF THE DRAWINGS

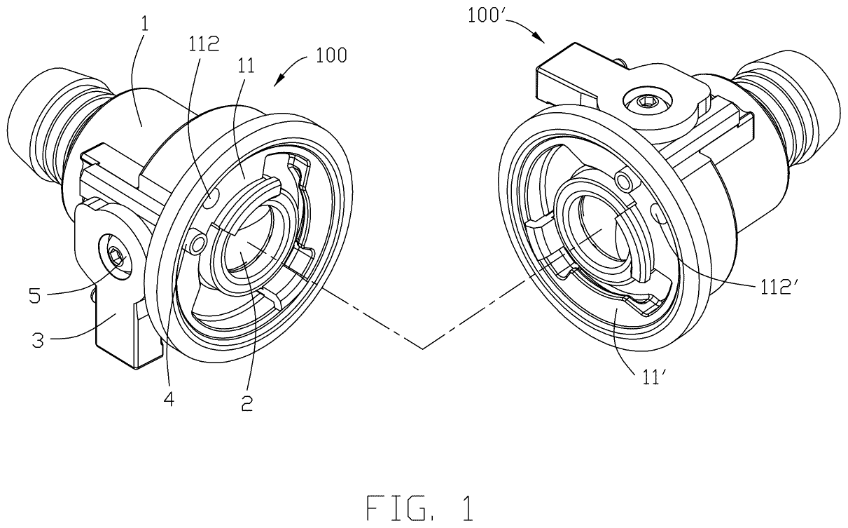

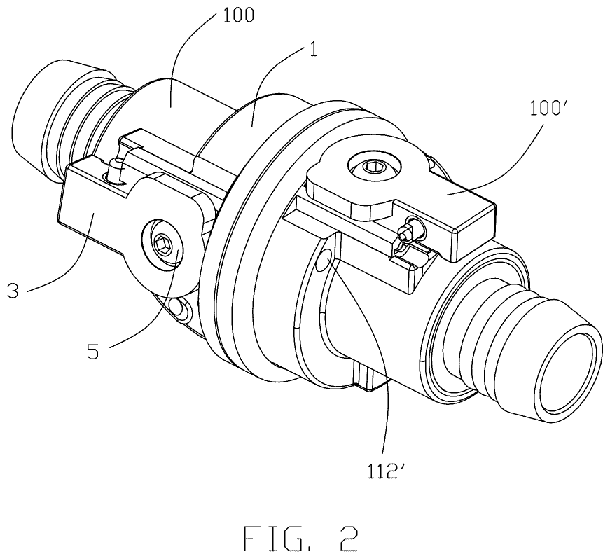

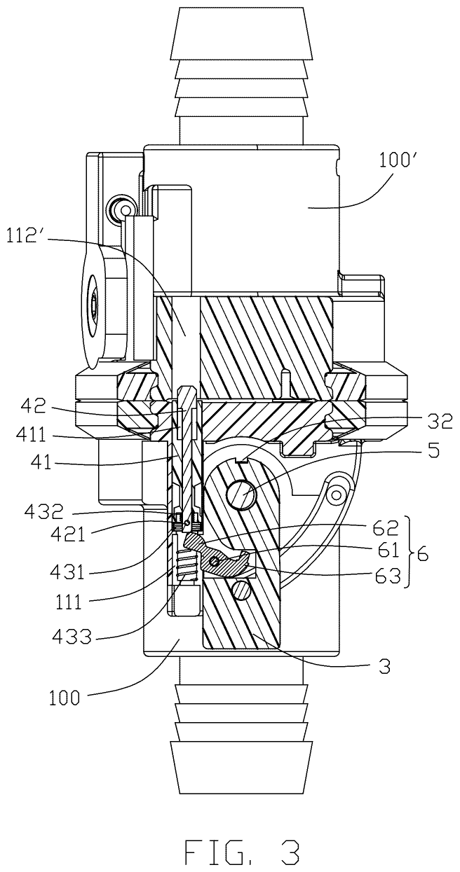

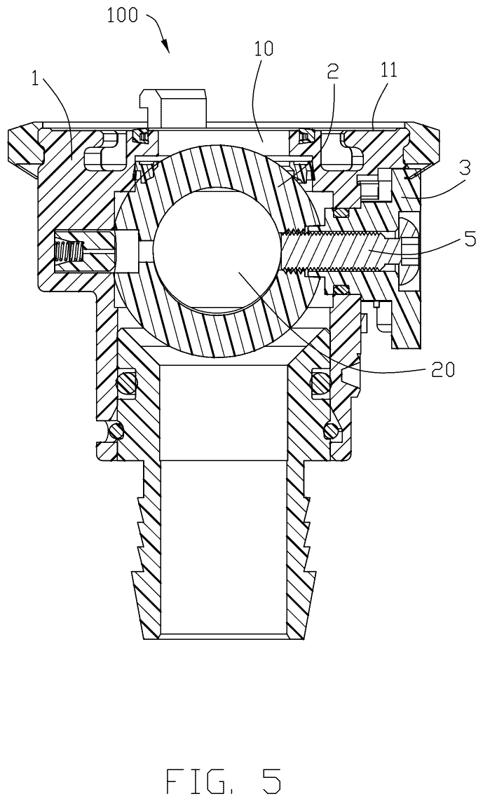

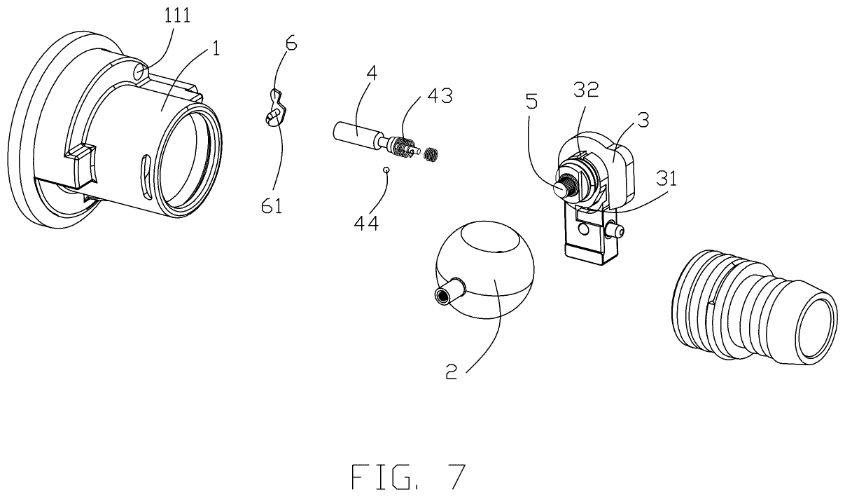

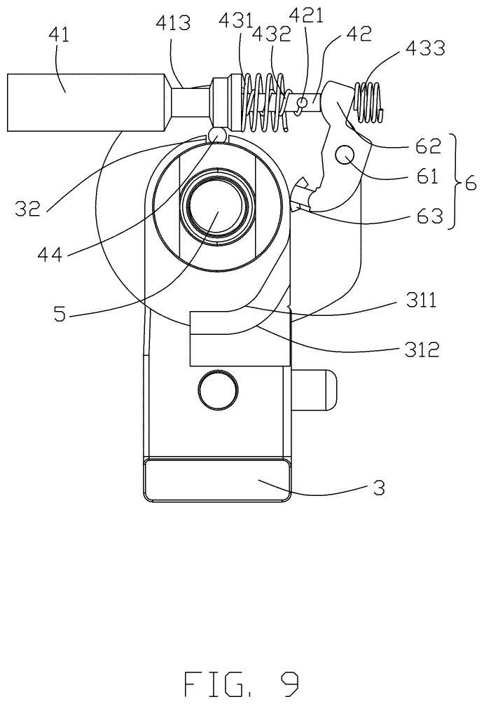

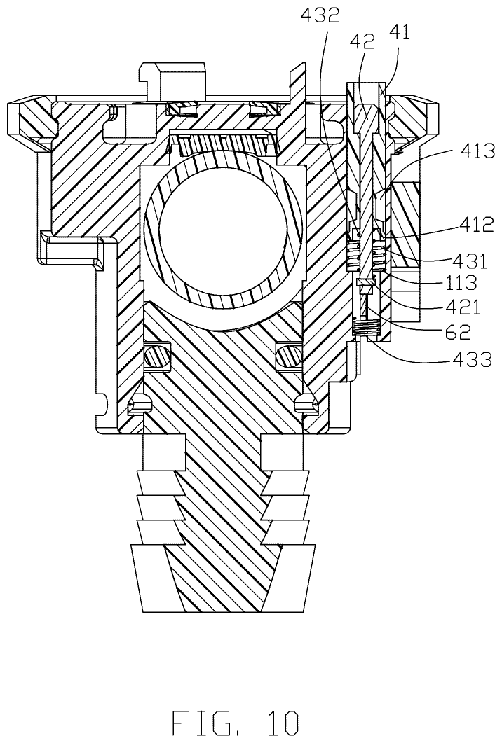

Referring to FIGS. 1-15, the present disclosure discloses a fluid connector 100.

Referring to FIGS. 1-5, the fluid connector 100 mates with a mating connector 100′ in fluid communication with each other. In this embodiment, the mating connector 100′ has a same structure as the fluid connector 100. The fluid connector 100 includes a shell 1 having a fluid channel 10, a valve member 2 rotatably accommodated in the fluid channel 10 and having a through hole 20, a control element 3 connected to the valve member 2 for controlling the valve member 2 to rotate between a closed position in which the valve member 2 obstructs the fluid channel 10 and an open position in which the valve member 2 does not obstruct the fluid channel 10, and an interlock system 4. The control element 3 is configured as a handle fixedly connected to the valve member 2 via a screw 5. The shell 1 has an interface 11 for abutting the mating connector 100′. An accommodating hole 111 is concavely formed on the interface 11 to accommodate the interlock system 4.

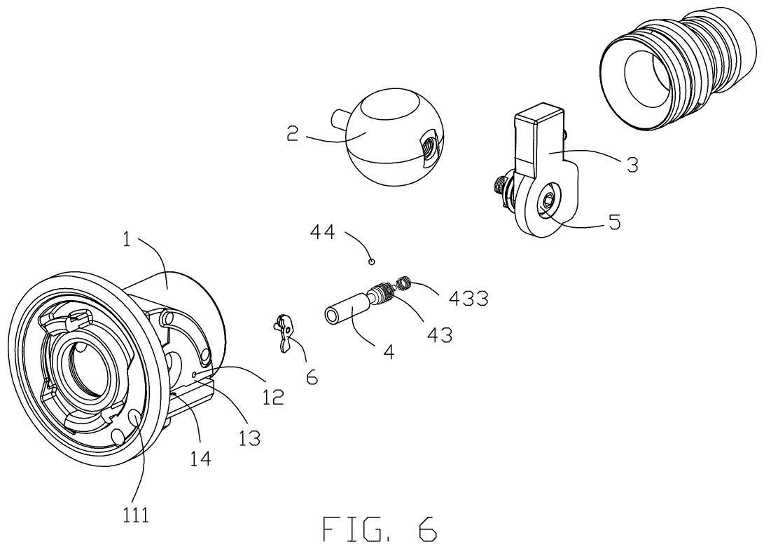

Please further refer to FIGS. 6-10, which illustrate the state of the fluid connector 100 before abutting the mating connector 100′. The interlock system 4 includes a first pin 41 movable within the accommodating hole 111, a second pin 42 movable within the accommodating hole 111, and a resilient system 43 that supports the first pin 41 and the second pin 42. The resilient system 43 includes a first spring 431 that supports the first pin 41 and a second spring 432 that supports the second pin 42. The first pin 41 has a receiving cavity 411 for receiving the second pin 42. The second pin 42 is coaxially arranged with the first pin 41 and can move relative to the first pin 41 within the receiving cavity 411 in an axial direction that the fluid channel 10 extends in. Both the interfaces 11/11′ of the fluid connector 100 and the mating connector 100′ are provided with mating holes 112/112′. The diameter of the mating hole 112′ of the mating connector 100′ is smaller than that of the first pin 41 of the fluid connector 100 and is larger than that of the second pin 42 so that only the second pin 42 of the two pins can be inserted into the mating hole 112′.

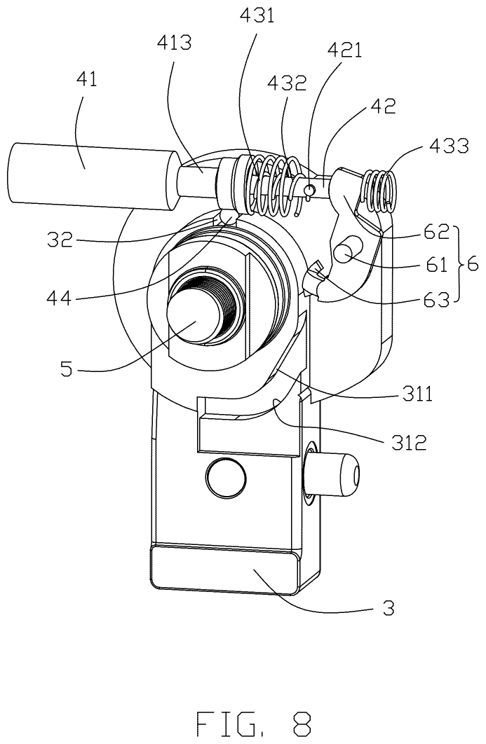

As shown in FIGS. 8-10, the accommodating hole 111 is provided with an inwardly protruding step 113. One end of the first spring 431 is supported on the surface of the protruding step 113, and the other end of the first spring 431 abuts the first pin 41. The first spring 431 supports the first pin 41, enabling the first pin to move between a first position in which the first pin 41 protrudes outwardly from the interface 11 and a second position in which the first pin 41 retracts inwardly compared to the first position. The lower end of the second pin 42 is further provided with a supporting portion 421 for contacting the second spring 432 in a vertical direction. In this embodiment, the supporting portion 421 is configured as a cylinder inserted into the lower end of the second pin 42 in a transverse direction perpendicular to the vertical direction. In other embodiments, the supporting portion 421 may alternatively be other possible structures that are capable of supporting the second spring 432 in the vertical direction. The second spring 432 is coaxially arranged inside the first spring 431. The upper end of the second spring 432 abuts a platform 412 concavely formed from the lower end of the first pin 41, and the lower end of the second pin 432 abuts the supporting portion 421. The fluid connector 100 further includes an operating member 6 that operatively connects the control element 3 to the interlock system 4. The operating member 6 is movably mounted in a mounting hole 12 on the shell 1 via a securing bar 61 and is rotatable around the securing bar 61 which serves as an axis. A slide groove 31 is concavely formed on one side of the control element 3 facing the valve member 2. The operating member 6 further includes a leg 62 that abuts the lower end of the second pin 42 and a driving portion 63 that moves within the slide groove 31. The control element 3 rotates around the screw 5 to operate the valve member 2 between the open position and the closed position. The slide groove 31 has an inner wall 311 close to a rotation axis of the screw 5 and an outer wall 312 opposite the inner wall 311. As shown in FIG. 6, a narrow groove 13 penetrating the wall of the shell 1 is formed on the side surface of the accommodating hole 111, and the leg 62 of the operating member 6 passes through the narrow groove 13 and enters the accommodating hole 111.

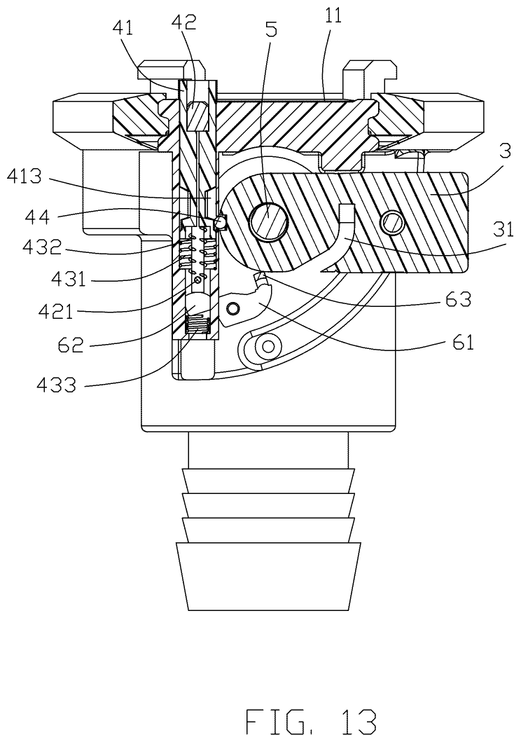

Please refer to FIGS. 13-15, which respectively illustrate state of the fluid connector 100 before abutting, the state of the fluid connector after abutting when the control element 3 closes the valve member 2, and the state of the fluid connector after abutting when the control element 3 opens the valve member 2. The interlock system 4 further includes a restricting member 44 disposed between the first pin 41 and the control element 3. The restricting member 44 is configured as a roll ball. The control element 3 is provided with a recess 32 that is engaged with the restricting member 44. The outer surface of the first pin 41 is recessed with an engagement groove 413 that cooperates with the restricting member 44. The side of the accommodating hole 111 further includes a through groove 14 that runs through the wall of the shell 1. The restricting member 44 is selectively movable between the recess 32 and the engagement groove 413 via the through groove 14. A third spring 433 is disposed within the accommodating hole 111 to support the leg 62. The third spring 433 and the second pin 42 jointly clamp the support leg 62 in the vertical direction to maintain the relative stability of the position between the driving portion 63 and the control element 3.

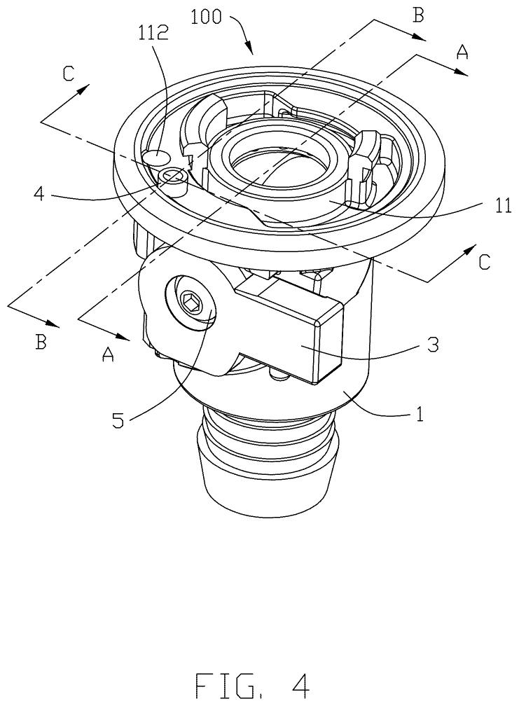

As shown in FIGS. 4 and 13, when the fluid connector 100 does not abut an object, the first pin 41 is supported by the first spring 431 and is in the first position. The restricting member 44 is removed from the engagement groove 413 and pushed into the recess 32 by the first pin 41. At this moment, the restricting member 44 restricts rotation of the control element 3. The second pin 42 is in a retracting position accommodated in the accommodating hole 111 and does not extend beyond the interface 11. In other embodiments, the retracted second pin 42 may also extend beyond the interface 11.

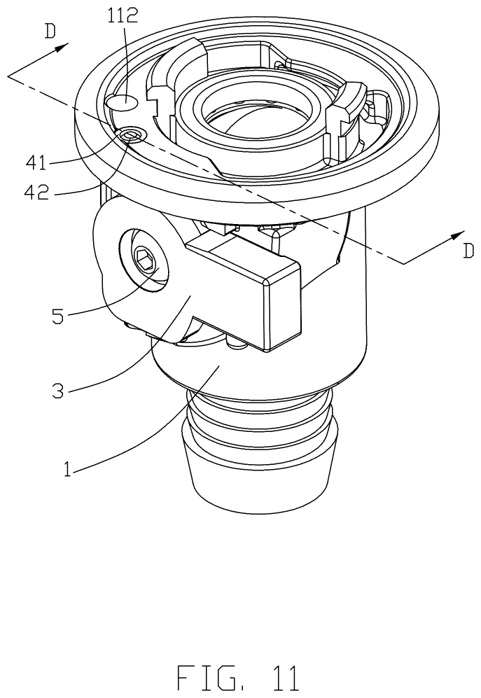

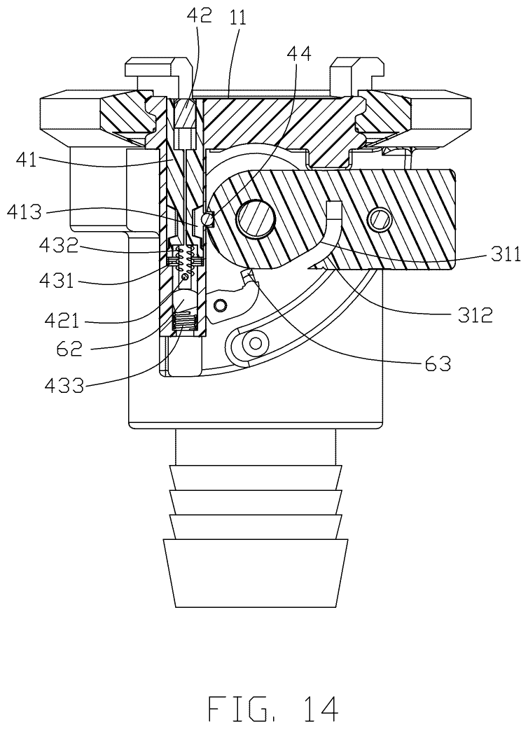

As shown in FIGS. 11 and 14, when the fluid connector 100 abuts the mating connector 100′, the control element 3 closes the valve member 2. The first pin 41 is biased by the mating connector 100′ and maintained in the second position. The recess 32, the through groove 14, and the engagement groove 413 are aligned with each other. When the restricting member 44 moves from the recess 32 through the through groove 14 to the engagement groove 413, the restricting member 44 is free of the rotating restriction on the control element 3. The control element 3 is rotatable, and rotating the control element 3 can drive the restricting member 44 from the recess 32 into the engagement groove 413. The first pin 41, held in the second position, compresses the second spring 432 to ensure that the driving portion 63 is aligned with the slide groove 31.

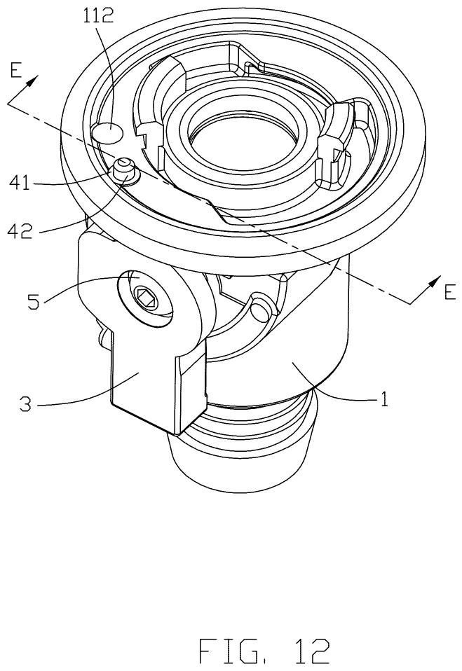

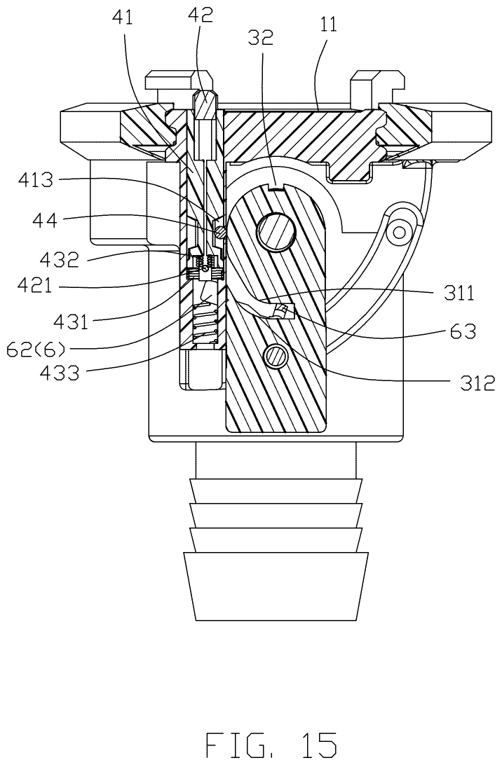

As shown in FIGS. 12 and 15, when the fluid connector 100 abuts the mating connector 100′, the control element 3 opens the valve member 2. The driving portion 63 is pushed against the inner wall 311, thereby rotating the operating member 6 around the securing bar 61. The leg 62 moves upwardly, pushing the second pin 42 outwardly to an extending position. The supporting portion 421, which moves to the extending position along with the second pin 42, further compresses the second spring 432.

When the control element 3 operates the valve member 2 to move from the open position to the closed position, the driving portion 63 moves out of the slide groove 31, releasing the pushing force on the second pin 42. One end of the second spring 432 abuts the platform 412 of the first pin 41, and the other end abuts the supporting portion 421 of the second pin 42. The first pin 41 is biased to be remained in the second position. The second spring 432, via the supporting portion 421, pushes the second pin 42 from the extending position to the retracting position.

Of note, the fluid connector 100 of the present disclosure can engage mating connectors having different structures, as long as the mating connector has a mating hole allowing the second pin 42 of the fluid connector 100 to be inserted and positioned at the extending position, thereby unlocking the valve member 2, and a pin member of the mating connector can be inserted into the mating hole of the fluid connector 100 for unlocking the ball valve.

1. A fluid connector comprising:
a shell having a fluid channel;
a valve member rotatably accommodated in the fluid channel and having a through hole;
a control element connected to the valve member for controlling the valve member to rotate between a closed position in which the valve member obstructs the fluid channel and an open position in which the valve member opens the fluid channel; and
an interlock system; wherein
the shell has an interface for abutting a mating connector and an accommodating hole concavely formed on the interface to accommodate the interlock system;
the interlock system includes a first pin selectively movable within the accommodating hole between a first position in which the first pin protrudes outwardly from the interface and a second position in which the first pin retracts inwardly compared to the first position, a second pin movable within the accommodating hole, and a resilient system for engaging the first pin and the second pin;
when the fluid connector does not abut the mating connector, the resilient system maintains the first pin in the first position, and the interlock system further includes a restricting member preventing the control element from rotating the valve member;
when the fluid connector abuts the mating connector, the first pin is biased from the first position to the second position, and the control element is free of restriction by the restricting member so that the control element can operate the valve member to rotate between the closed position and the open position; and
the fluid connector further includes an operating member operatively connected to the control element and the interlock system; when the control element opens the valve member, the second pin can be pushed to an extending position by the operating member; and when the control element closes the valve member, the second pin can move to a retracting position accommodated in the accommodating hole.

2. The fluid connector according to claim 1, wherein the first pin has a receiving cavity for receiving the second pin, and the second pin is able to move in an axial direction relative to the first pin in the receiving cavity.

3. The fluid connector according to claim 1, wherein:
the restricting member is set between the control element and the first pin, the control element has a recess for receiving the restricting member, and the restricting member is configured as a ball;
the outer surface of the first pin is recessed with an engagement groove that cooperates with the restricting member;
the side of the accommodating hole has a through groove passing through the wall of the shell;
the restricting member is selectively movable between the recess and the engagement groove via the through groove;
when the first pin is in the first position, the restricting member is excluded from the engagement groove and pushed into the recess by the first pin, and the restricting member restricts the rotation of the control element; and
when the first pin is in the second position, the through groove is aligned with the recess and the engagement groove so that the control element is able to be rotated to drive the restricting member from the recess into the engagement groove.

4. The fluid connector according to claim 1, wherein the resilient system includes a first spring supporting the first pin to move between the first position and the second position and a second spring supporting the second pin to move between the extending position and the retracting position.

5. The fluid connector according to claim 4, wherein the accommodating hole has a step surface supporting the first spring, the second pin has a supporting portion contacting the second spring in a vertical direction; the second spring is coaxially arranged on the inner side of the first spring; and one end of the second spring contacts the supporting portion and the other end of the second spring contacts the first pin.

6. The fluid connector according to claim 1, wherein when the fluid connector does not abut the mating connector, the second pin is supported by the operating member in the retracting position, and the second pin does not exceed the interface.

7. The fluid connector according to claim 1, wherein:
the control element has a slide groove;
the operating member includes a leg abutting the second pin, a driving portion able to move in the slide groove, and a securing bar movably arranged on the shell; and
the operating member is able to rotate about the securing bar.

8. The fluid connector according to claim 7, wherein the slide groove has an inner wall close to a rotation axis of the control element and an outer wall; and when the control element opens the valve member, the driving portion is pushed by the inner wall for driving the leg to move, and the second pin is pushed upwardly out of the accommodating hole.

9. The fluid connector according to claim 8, wherein when the valve member is operated by the control element from the open position to the closed position, the driving portion move out of the slide groove, and one end of the second spring supports the first pin and the other end of the second spring abuts the supporting portion to push the second pin downward to the retracting position.

10. The fluid connector according to claim 1, wherein the fluid connector further includes a third spring supporting the operating member, and the operating member is sandwiched between the third spring and the second pin in a vertical direction.

11. The fluid connector according to claim 1, wherein an interface of the mating connector has a mating hole for being inserted by the second pin of the fluid connector, a diameter of the mating hole is smaller than a diameter of the first pin of the fluid connector, and the interface of the fluid connector has an other mating hole for being inserted by a second pin of the mating connector.

12. A connector assembly, having two fluid connectors each according to claim 1 being aligned along a mating axis and releasably connected to each other, wherein when the two fluid connectors abut with each other and one of the control elements operates the valve member to rotate to the open position, one second pin is pushed to the extending position to prevent the two fluid connectors from rotating relatively about the mating axis.

13. A fluid connector comprising:
a shell having a fluid channel;
a valve member rotatably accommodated in the fluid channel and having a through hole;
a control element connected to the valve member for controlling the valve member to rotate between a closed position in which the valve member obstructs the fluid channel and an open position in which the valve member opens the fluid channel; and
an interlock system that permits movement of the control element for operating the valve member from the closed position to the open position when a mating connector is connected to the shell;
wherein the shell has an interface for abutting a mating connector and an accommodating hole concavely formed on the interface to accommodate the interlock system; wherein
the interlock system includes a first pin selectively movable within the accommodating hole between a first position in which the first pin protrudes outwardly from the interface and a second position in which the first pin retracts inwardly compared to the first position, a second pin movable within the accommodating hole, and a first spring supporting the first pin;
when the fluid connector does not abut the mating connector, the first spring maintains the first pin in the first position, and the interlock system further includes a restricting member preventing the control element from rotating the valve member;
when the fluid connector abuts the mating connector, the first pin is biased by the mating connector from the first position to the second position, and the control element is free of restriction by the restricting member so that the control element operates the valve member to rotate between the closed position and the open position; and
the fluid connector further includes an operating member operatively connected to the control element and the second pin; when the control element opens the valve member, the second pin is pushed to an extending position by the operating member; and when the control element closes the valve member, the second pin is moved to a retracting position accommodated in the accommodating hole.

14. The fluid connector according to claim 13, wherein the fluid connector further includes a third spring supporting the operating member, and the operating member is sandwiched between the third spring and the second pin in a vertical direction.

15. The fluid connector according to claim 13, wherein the first pin has a receiving cavity for receiving the second pin, and the second pin is able to move in an axial direction relative to the first pin in the receiving cavity.

16. The fluid connector according to claim 13, wherein when the fluid connector does not abut the mating connector, the second pin is supported by the operating member in the retracting position, and the second pin does not exceed the interface.

17. The fluid connector according to claim 13, wherein the interlock system further includes a second spring supporting the second pin to move between the extending position and the retracting position; one end of the second spring is biased by the first pin and the other end of the second spring is biased by a supporting portion arranged in the second pin; and the second spring is coaxially arranged on the inner side of the first spring.

18. The fluid connector according to claim 17, wherein the control element concavely has a slide groove; the operating member includes a leg abutting the second pin, a driving portion to move in the slide groove, and a securing bar movably arranged on the shell; and the operating member is able to rotate around the securing bar.

19. The fluid connector according to claim 18, wherein the slide groove has an inner wall close to a rotation axis of the control element and an outer wall; and when the control element opens the valve member, the driving portion is pushed by the inner wall for driving the leg to move, and the second pin is pushed upwardly out of the accommodating hole.

20. The fluid connector according to claim 19, wherein when the valve member is operated by the control element from the open position to the closed position, the driving portion move out of the slide groove, and one end of the second spring supports the first pin and the other end of the second spring abuts the supporting portion to push the second pin downward to the retracting position.
